(19) United States
(12) Patent Application Publication
(10) Pub. No.: US 2020/0065896 A1
(43) Pub. Date: Feb. 27, 2020

(54) SYSTEM FOR PROCESSING OF FINANCIAL LOAN TO USER IN EXCHANGE OF METAL ASSET

(71) Applicant: Finahub Technology Solutions Private Limited, Thuruthikkara (IN)

(72) Inventors: Rajesh SUKUMARAN, Trivandrum (IN); Ajith Kanjhiramkoloth GEORGE, Thuruthikkara (IN)

(21) Appl. No.: 16/109,687

(22) Filed: Aug. 22, 2018

(51) Int. Cl. G06Q 40/02; G06N 99/00; G06K 19/06

(52) U.S. Cl. CPC G06Q 40/025; G06K 19/06037; G06N 99/005

(57) ABSTRACT

The present disclosure provides a system for providing financial asset to a user in exchange of metal asset. The system includes a plurality of input devices to receive a first set of data from the user. In addition, the system includes a plurality of inlets to accept a plurality of inputs from the user and an operator. Also, the system includes a weighing mechanism to weigh the metal asset. Further the system includes a packaging mechanism to pack and mark the metal asset with a QR code. Further, the system includes a communication circuitry to transfer value of the financial asset to financial account associated with the user.

### INTRODUCTION

Financial institutions provide financial asset to individuals, businesses and the like. The financial asset is provided in form of personal loan, home loan, gold loan, secure loan and the like. Typically, the financial institutions provide financial asset to the individual based on some asset as collateral for repayment of the financial asset. The financial institutions provide the financial asset to the borrower in exchange of some valuable asset such as gold, silver and platinum as collateral from the borrower. The borrower has to approach the financial institution with the required documents and the valuable assets. In addition, the financial institution manually authenticates the borrower before providing the financial asset to the borrower. The authentication of the borrower consumes a lot of time and energy of the borrower and the financial institution. Further, the borrower needs to take the valuable asset to the financial institution personally to receive the financial asset from the financial institution that may be located at a distant location. Furthermore, the financial institution checks for purity of the valuable assets. Also, the financial institution manually measures weight of the valuable asset to calculate value of the financial asset to be provided to the borrower. The entire process for getting the financial asset from the financial institute consumes a lot of time and energy of the borrower and the financial institution. In addition, the financial institution is not accessible 24×7 because of which the individual having urgent requirement of the financial asset has to wait until opening of the financial institution. In light of the above mentioned discussion, there is a need for a system to overcome the above stated disadvantages.

### SUMMARY

In a first example, a system is provided. The system provides financial asset to a user in exchange of metal asset. The system may include a plurality of input devices. In addition, the system may include a plurality of inlets. Moreover, the system may include a video imaging mechanism. Further, the system may include a weighing mechanism. Also, the system may include a packaging mechanism. Further, the system may include a communication circuitry. The plurality of input devices may be used to receive a first set of data from the user. The first set of data may be used to authenticate the user. The plurality of inlets may be used to accept a plurality of inputs from the user and an operator. The user provides the metal asset through a first inlet from the plurality of inlets. The first inlet opens up after authentication of the user. The operator uses a third inlet from the plurality of inlets and a fourth inlet from the plurality of inlets to manually inspect the metal asset. The operator performs manual inspection in an inspection region to check purity and fineness of the metal asset. Further, the video imaging mechanism is configured to feed video inputs to a machine learning system in real time. The machine learning system may be located remotely from the system through any communication medium. The machine learning system augments manual purity checking process for the metal asset using the video inputs. The machine learning system predicts purity of the metal asset based on analysis of the video inputs. The weighing mechanism is used to weigh the metal asset. The metal asset is weighed after successful inspection of purity of the metal asset by the operator. The packaging mechanism is used to pack and mark the metal asset with a QR code. The QR code enables identification of the metal asset provided by the user. The QR code is utilized for returning the metal asset to the user when the financial asset is repaid by the user. The packed metal asset is transferred to a secure region through a fifth inlet of the plurality of inlets. The communication circuitry is used to transfer value of the financial asset to financial account associated with the user. The financial account information associated with the user is fetched from a user profile stored in a database. The financial asset is transferred to the financial account of the user after successful inspection of the metal asset and acceptance of value of the financial asset by the user.

In an embodiment of the present disclosure, the metal asset may include one of gold, silver, platinum and valuable metals. The metal asset is exchanged to receive the financial asset.

In an embodiment of the present disclosure, the first set of data is received from the plurality of input devices. The first set of data may include login credentials and one or more proof of identity or any type of unique identification number associated with the user. The plurality of input devices includes an integrated fingerprint sensor, a keyboard, a camera, a touchscreen display and a plurality of biometric devices.

In an embodiment of the present disclosure, the first set of data is used to fetch a second set of data associated with the user. The second set of data includes demographic information, financial account information, fingerprint details, details stored in one or more proof of identity or associated with any type of unique identification number associated with the user.

In an embodiment of the present disclosure, the plurality of inlets includes the first inlet, a second inlet, the third inlet, the fourth inlet, a fifth inlet and a sixth inlet. The first inlet receives the metal asset from the user after authentication of the user. The second inlet receives the metal asset from the first inlet. The second inlet transfers the metal asset to the weighing mechanism. The third inlet and the fourth inlet allow the operator to manually inspect the metal asset. The fifth inlet transfers the metal asset to the packaging mechanism from the weighing mechanism. The sixth inlet transfers the packed metal asset from the packaging mechanism to the secure region.

In an embodiment of the present disclosure, the manual inspection in the inspection region is done using a plurality of inspection devices. The plurality of inspection devices include one or more high resolution cameras, a set of tamper proof gloves, a touchstone, electronic purity testing device for testing purity of precious metals, one or more lighting devices and a viewfinder.

In an embodiment of the present disclosure, the weighing mechanism includes a lowering device, a basin of the precision weighing scale and the precision weighing scale. The lowering device lowers the metal asset from the second inlet to a precision weighing scale. The basin of the precision weighing scale is used to hold the metal asset during measurement of weight of the metal asset. The precision weighing scale is used to measure weight of the metal asset. The weight of the metal asset is measured to calculate value of the financial asset to be provided to the user. The metal asset is transferred to the precision weighing scale after manual inspection of the metal asset.

In an embodiment of the present disclosure, the system outputs information associated with current transaction using a plurality of output devices. The plurality of output devices includes a QR code generator, an integrated thermal printer, a screen, a speaker and a LED light.

In an embodiment of the present disclosure, the metal asset is provided back to the user through an outlet. The metal asset is provided back to the user when the metal asset is rejected in manual inspection by the operator. The metal asset is provided back to the user when the user rejects the value of the financial asset provided by the system. The system stores or documents details about each transaction related to provision of the financial asset provided to the user for documentary evidence to reduce risks of fraud by the operator.

In an embodiment of the present disclosure, the packed metal asset is transferred to the secure region. The packed metal asset is transferred to the secure region after acceptance of value of the financial asset generated. The value of the financial asset is generated in real-time based on a plurality of factors.

In a second example, a system is provided. The system provides financial asset to a user in exchange of metal asset. The system may include a plurality of input devices. In addition, the system may include a plurality of inlets. Moreover, the system may include a video imaging mechanism. Further, the system may include a weighing mechanism. Also, the system may include a packaging mechanism. Further, the system may include a communication circuitry. The plurality of input devices may be used to receive a first set of data from the user. The first set of data may be used to authenticate the user. The plurality of inlets may be used to accept a plurality of inputs from the user and an operator. The user provides the metal asset through a first inlet from the plurality of inlets. The first inlet opens up after authentication of the user. The operator uses a third inlet from the plurality of inlets and a fourth inlet from the plurality of inlets to manually inspect the metal asset. The operator performs manual inspection in an inspection region to check purity and fineness of the metal asset. Further, the video imaging mechanism is configured to feed video inputs to a machine learning system in real time. The machine learning system may be located remotely from the system through any communication medium. The machine learning system augments manual purity checking process for the metal asset using the video inputs. The machine learning system predicts purity of the metal asset based on analysis of the video inputs. The weighing mechanism is used to weigh the metal asset. The metal asset is weighed after successful inspection of purity of the metal asset by the operator. The packaging mechanism is used to pack and mark the metal asset with a QR code. The QR code enables identification of the metal asset provided by the user. The QR code is utilized for returning the metal asset to the user when the financial asset is repaid by the user. The packed metal asset is transferred to a secure region through a fifth inlet of the plurality of inlets. The communication circuitry is used to transfer value of the financial asset to financial account associated with the user. The financial account information associated with the user is fetched from a user profile stored in a database. The financial asset is transferred to the financial account of the user after successful inspection of the metal asset and acceptance of value of the financial asset by the user. The system outputs information associated with current transaction using a plurality of output devices. The plurality of output devices includes a QR code generator, an integrated thermal printer, a screen, a speaker and a LED light.

In an embodiment of the present disclosure, the metal asset may include one of gold, silver, platinum and valuable metals. The metal asset is exchanged to receive the financial asset.

In an embodiment of the present disclosure, the first set of data is received from the plurality of input devices. The first set of data may include login credentials and one or more proof of identity or any type of unique identification number associated with the user. The plurality of input devices includes an integrated fingerprint sensor, a keyboard, a camera, a touchscreen display and a plurality of biometric devices.

In an embodiment of the present disclosure, the first set of data is used to fetch a second set of data associated with the user. The second set of data includes demographic information, financial account information, fingerprint details, details stored in one or more proof of identity or associated with any type of unique identification number associated with the user.

In an embodiment of the present disclosure, the plurality of inlets includes the first inlet, a second inlet, the third inlet, the fourth inlet, a fifth inlet and a sixth inlet. The first inlet receives the metal asset from the user after authentication of the user. The second inlet receives the metal asset from the first inlet. The second inlet transfers the metal asset to the weighing mechanism. The third inlet and the fourth inlet allow the operator to manually inspect the metal asset. The fifth inlet transfers the metal asset to the packaging mechanism from the weighing mechanism. The sixth inlet transfers the packed metal asset from the packaging mechanism to the secure region.

In an embodiment of the present disclosure, the manual inspection in the inspection region is done using a plurality of inspection devices. The plurality of inspection devices include one or more high resolution cameras, a set of tamper proof gloves, a touchstone, electronic purity testing device for testing purity of precious metals, one or more lighting devices and a viewfinder.

In an embodiment of the present disclosure, the weighing mechanism includes a lowering device, a basin of the precision weighing scale and the precision weighing scale. The lowering device lowers the metal asset from the second inlet to a precision weighing scale. The basin of the precision weighing scale is used to hold the metal asset during measurement of weight of the metal asset. The precision weighing scale is used to measure weight of the metal asset. The weight of the metal asset is measured to calculate value of the financial asset to be provided to the user. The metal asset is transferred to the precision weighing scale after manual inspection of the metal asset.

In an embodiment of the present disclosure, the metal asset is provided back to the user through an outlet. The metal asset is provided back to the user when the metal asset is rejected in manual inspection by the operator. The metal asset is provided back to the user when the user rejects the value of the financial asset provided by the system. The system stores or documents details about each transaction related to provision of the financial asset provided to the user for documentary evidence to reduce risks of fraud by the operator.

In an embodiment of the present disclosure, the packed metal asset is transferred to the secure region. The packed metal asset is transferred to the secure region after acceptance of value of the financial asset generated. The value of the financial asset is generated in real-time based on a plurality of factors.

### BRIEF DESCRIPTION OF THE DRAWINGS

Having thus described the invention in general terms, reference will now be made to the accompanying drawings, which are not necessarily drawn to scale, and wherein:

FIG. 1A, FIG. 1B, FIG. 1C and FIG. 1D illustrate a system for providing financial asset to a user in exchange of metal asset, in accordance with various embodiments of the present disclosure;

FIG. 2A illustrates a perspective view of upper compartment of the system for providing the financial asset to the user in exchange of the metal asset, in accordance with an embodiment of the present disclosure;

FIG. 2B illustrates a perspective view of lower compartment of the system for providing the financial asset to the user in exchange of the metal asset, in accordance with an embodiment of the present disclosure;

FIG. 3A, FIG. 3B and FIG. 3C illustrate a block diagram of a method for providing financial asset to the user in exchange of metal asset, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

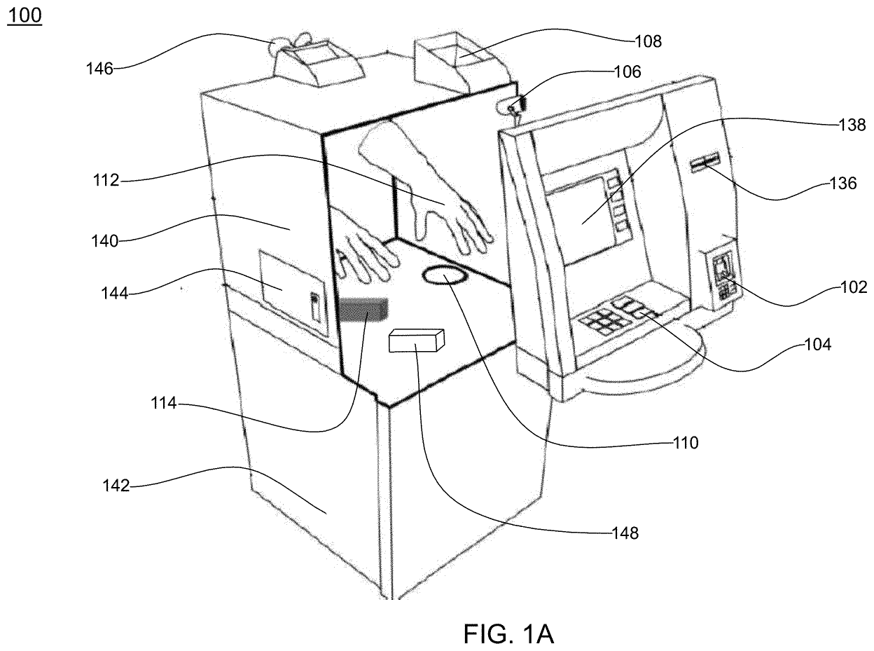

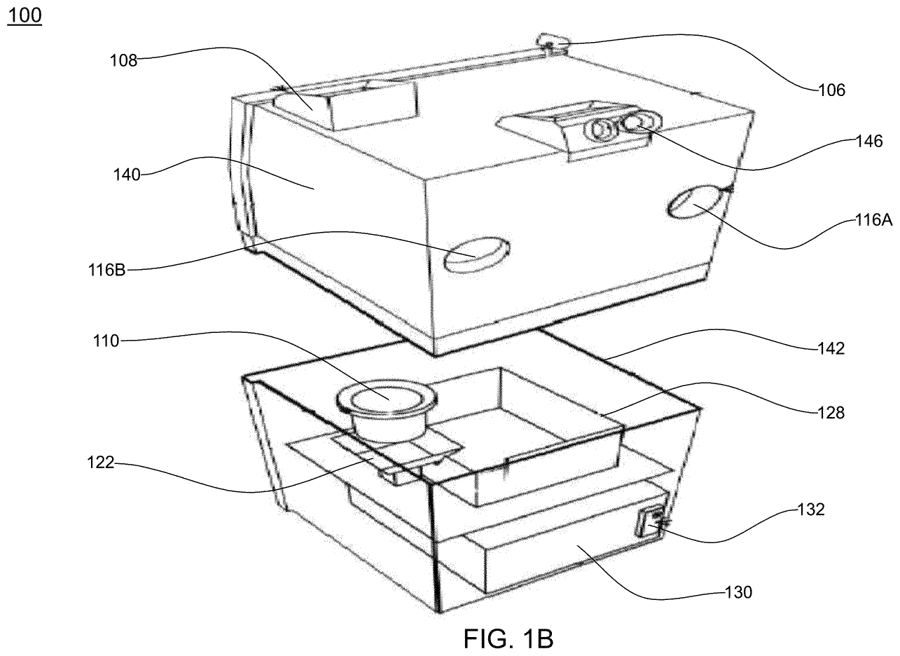

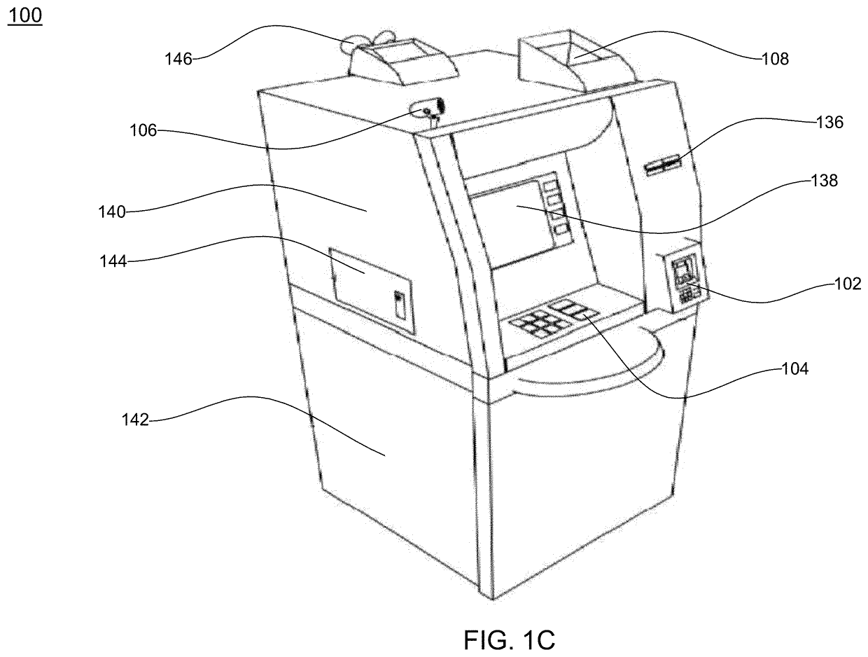

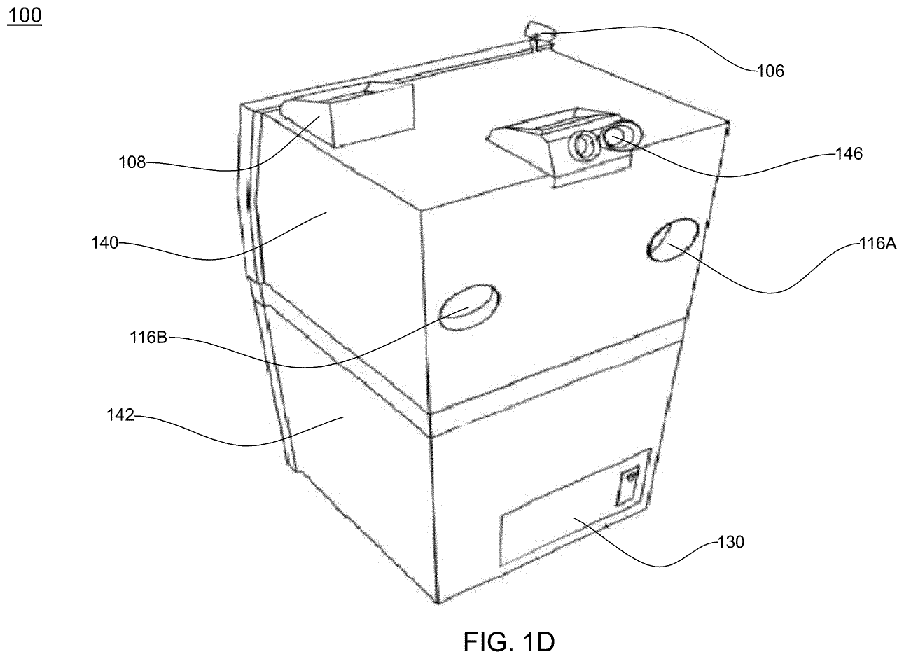

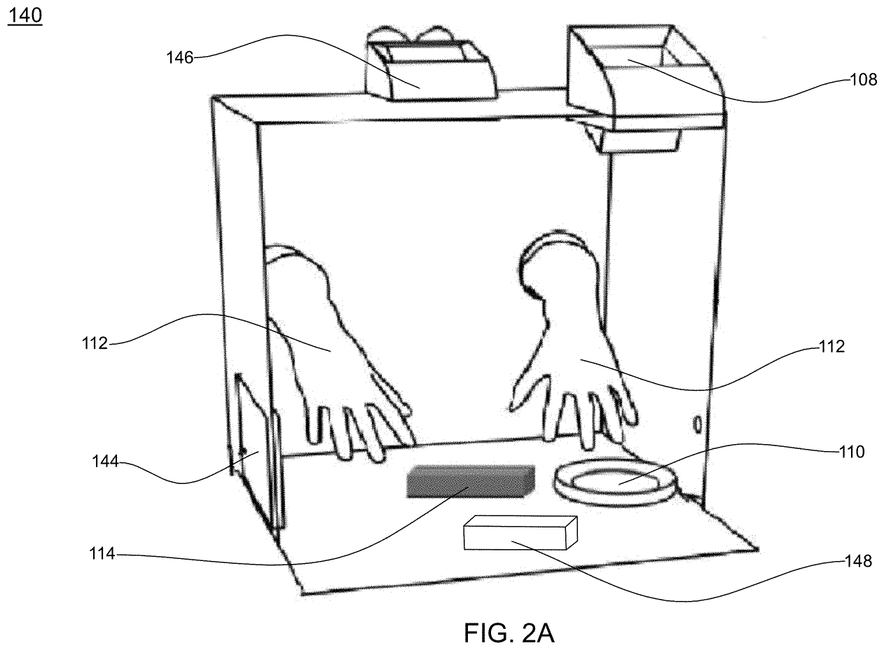

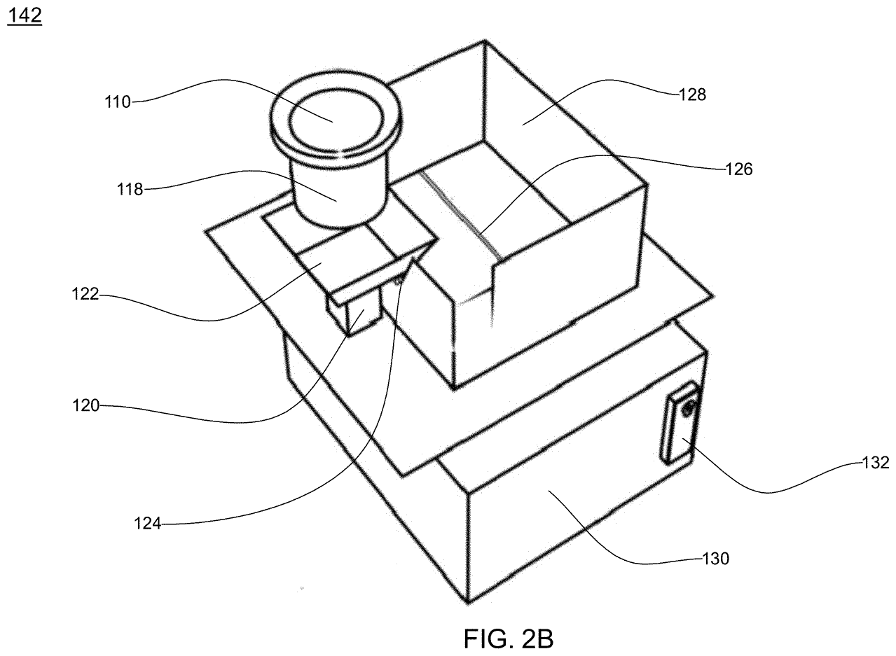

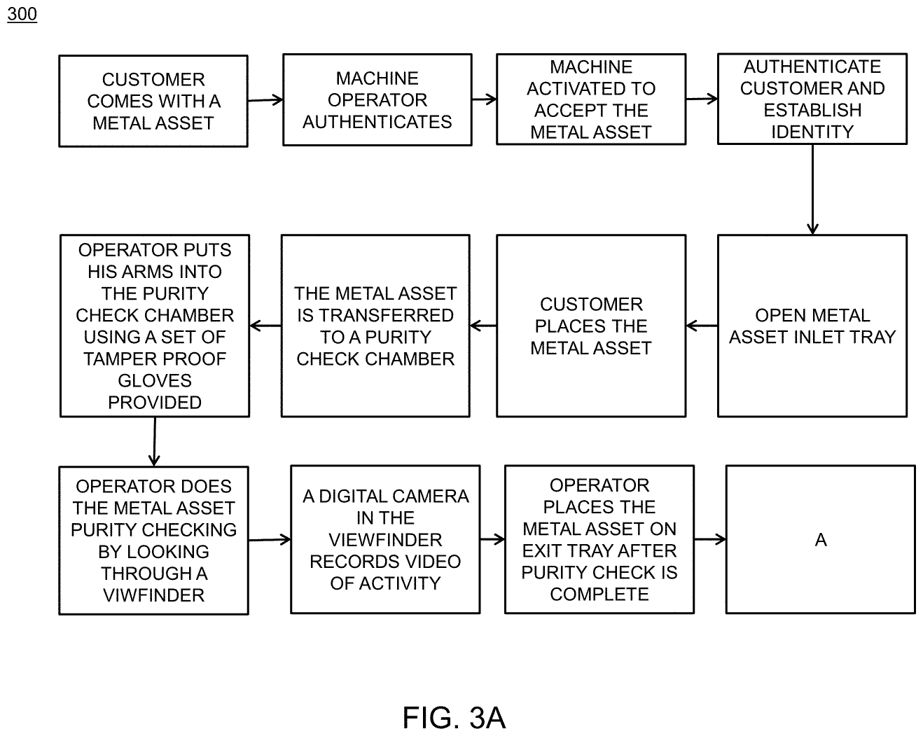

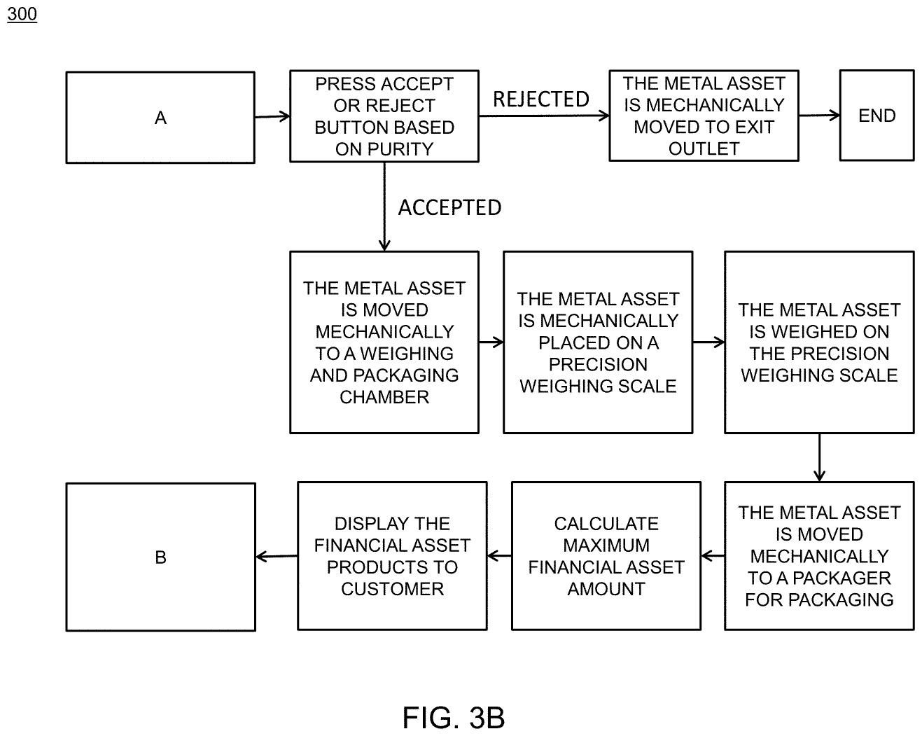

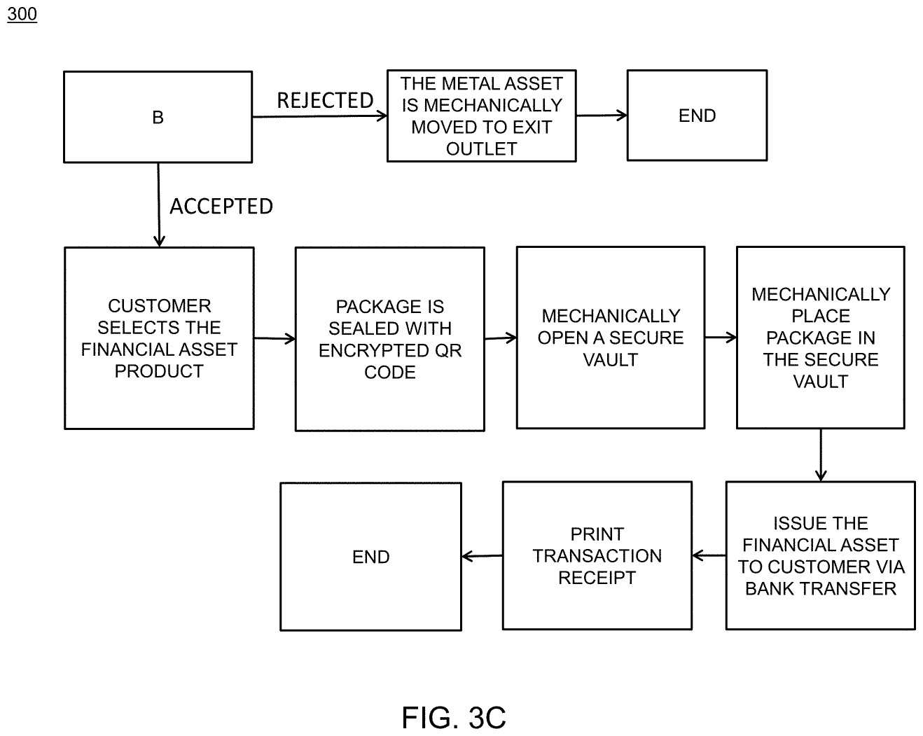

FIG. 1A, FIG. 1B, FIG. 1C and FIG. 1D illustrates various perspective views of a system 100 for providing financial asset to a user in exchange of metal asset, in accordance with various embodiments of the present disclosure. FIG. 2A illustrates a perspective view of an upper compartment 140 of the system 100 for providing the financial asset to the user in exchange of the metal asset, in accordance with various embodiments of the present disclosure. FIG. 2B illustrates a perspective view of lower compartment 142 of the system 100 for providing the financial asset to the user in exchange of the metal asset, in accordance with various embodiments of the present disclosure. In an embodiment of the present disclosure, FIG. 1A, FIG. 1B, FIG. 1C, FIG. 1D, FIG. 2A and FIG. 2B constitutes a machine for providing the financial asset to the user in exchange of the metal asset. FIG. 3 illustrates a block diagram of a method for providing financial asset to the user in exchange of metal asset, in accordance with various embodiments of the present disclosure.

The system 100 includes an integrated fingerprint sensor 102, a keyboard 104, a camera 106, a first inlet 108, a second inlet 110, a set of tamper proof gloves 112 and a touchstone 114. Further, the system 100 includes a third inlet 116a and a fourth inlet 116b, a lowering device 118, a precision weighing scale 120, a basin 122 of the precision weighing scale 120, a tilting pivot 124, a fifth inlet 126, a packager 128, a secure vault 130 and a secure vault outlet 132. Furthermore, the system 100 includes a sixth inlet 134, an integrated thermal printer 136, a screen 138, the upper compartment 140, the lower compartment 142, an outlet 144, a viewfinder 146 and an electronic purity testing device 148. In an embodiment of the present disclosure, the upper compartment 140 includes the integrated fingerprint sensor 102, the keyboard 104, the camera 106, the first inlet 108 and the second inlet 110. Further, the upper compartment 140 includes the set of tamper proof gloves 112, the touchstone 114, the viewfinder 146, the third inlet 116a and the fourth inlet 116b, the integrated thermal printer 136, the screen 138 and the outlet 144. In an embodiment of the present disclosure, the lower compartment 142 includes the lowering device 118, the precision weighing scale 120, the basin 122 of the precision weighing scale 120, the tilting pivot 124, the fifth inlet 126 and the packager 128. Further, the lower compartment 142 includes the secure vault 130, the secure vault outlet 132 and the sixth inlet 134.

The system 100 is used by the user to perform a transaction. In general, the transaction is an agreement between two parties to exchange goods, services or financial instruments. The user is any person who wants to apply for the financial asset in exchange of the metal asset as collateral. In general, collateral refers to something pledged as security for repayment of loan, to be forfeited in the event of default. In an embodiment of the present disclosure, the metal asset includes one of gold, silver, platinum and valuable metals. The system 100 receives the metal asset as collateral and provides the financial asset to the user in return (as shown in FIG. 3). In addition, the user needs no special training to use the system 100. The user easily uses the system 100 by following instructions displayed on the screen 138. In an embodiment of the present disclosure, the instructions displayed on the screen 138 may be changed in any language according to preference of the user. In general, the financial asset is a non-physical asset whose value is derived from a contractual claim such as bank deposits, bonds, and stocks. The term financial asset here refers to help in the form of money. The financial asset refers to a loan taken from banks or financial institutions by people who are in need of money.

The system 100 provides medium to the user to request for the financial asset. The system 100 requires a suitable operating system to run. In general, the operating system is system software that manages hardware and software resources and provides common services for computer programs. In addition, the operating system acts as an interface for software installed in the system 100 to interact with hardware components of the system 100. In an embodiment of the present disclosure, the operating system installed in the system 100 is a mobile operating system. In an example, the mobile operating system includes but may not be limited to Windows operating system from Microsoft, Android operating system from Google, iOS operating system from Apple, Symbian based operating system from Nokia, Bada operating system from Samsung Electronics and BlackBerry operating system from BlackBerry. However, the operating system is not limited to above mentioned operating systems. In addition, the system 100 runs on any version of the above mentioned operating systems.

In another embodiment of the present disclosure, the system 100 runs on any suitable operating system designed for fixed computer device. In an example, the operating system installed in the system 100 is Windows from Microsoft, Mac from Apple and the like. In another example, the operating system installed in the system 100 is Linux based operating system. In yet another example, the operating system installed in the system 100 may be UNIX, Kali Linux, and the like. In an embodiment of the present disclosure, the system 100 runs on any version of Windows operating system. In another embodiment of the present disclosure, the system 100 runs on any version of Mac operating system. In another embodiment of the present disclosure, the system 100 runs on any version of Linux operating system. In yet another embodiment of the present disclosure, the system 100 runs on any version of above mentioned operating systems.

The system 100 is capable of performing necessary operations to provide the financial asset to the user in exchange of the metal asset. The system 100 includes a plurality of input devices. The plurality of input devices is used to receive a first set of data from the user. In an embodiment of the present disclosure, the first set of data is used to authenticate the user (as shown in FIG. 3). The first set of data is received from the plurality of input devices. The first set of data includes login credentials and one or more proof of identity or any type of unique identification number associated with the user. In an embodiment of the present disclosure, the plurality of input devices includes the integrated fingerprint sensor 102, the keyboard 104, the camera 106, a touchscreen display, a plurality of biometric devices and the like. In an example, the proof of identity associated with the user includes valid driver ID, country specific identity proof or any type of unique identification number such as AADHAR ID or emirates ID, PAN ID, birth certificate, school documents, passport, marriage certificate, government documents, court documents, ration card, electoral photo identity card, bank passbook, photo bank ATM card, photo bank credit card and the like. Further, the first set of data is used to fetch a second set of data associated with the user. The second set of data includes demographic information, financial account information, and fingerprint details, details stored in the one or more proof of identity or associated with any type of unique identification number associated with the user. The system 100 fetches the second set of data using hardware-run algorithms. In an embodiment of the present disclosure, the system 100 stores the first set of data in a user profile in a database associated with the system 100. In an embodiment of the present disclosure, the system 100 stores the fetched second set of data in the user profile in the database associated with the system 100. In an example, the hardware-run algorithms include data processing algorithms, machine learning algorithms and the like. In an embodiment of the present disclosure, the user profile includes fingerprint details, details stored in country specific identity proof or any type of unique identification number such as AADHAR ID or emirates ID associated with the user. In another embodiment of the present disclosure, the user profile includes financial account information, images associated with the user, demographic information of the user and the like. Further, the demographic information includes personal information of the user. The personal information includes but may not be limited to name, last name, age, gender, father name, mother name, mobile number, address, e-mail address and nationality of the user. Further, the financial account information includes bank account details, number of bank accounts associated with the user, number of credit cards and number of debit cards associated with the user and the like. In an example, the financial account information includes bank account, ATM card, Debit card, credit card, digital wallet, digital accounts and the like.

In an embodiment of the present disclosure, the system 100 initially authenticates the operator before the user can start a transaction (as shown in FIG. 3). In an embodiment of the present disclosure, the operator is authenticated through the integrated fingerprint sensor 102. The integrated fingerprint sensor 102 captures the fingerprint of the operator to authenticate the operator. The authentication is done based on a stored biometric identity of the operator in the database of the system 100. In another embodiment of the present disclosure, the operator may be authenticated by a biometric identity system provided on a back of the system 100. The authentication may be done through a fingerprint analysis, retinal scan and the like. The operator is authenticated each time a new user comes for a transaction. The integrated fingerprint sensor 102 captures fingerprint of the user to authenticate the user. Also, the integrated fingerprint sensor 102 is used to authenticate a new user to onboard details of the new user in the database. The authentication is done by mapping fingerprint of the user with fingerprint details of the user stored in the database. The integrated fingerprint scanner 102 is situated on front side of the system 100. The integrated fingerprint scanner 102 is easily accessible to the user. In an embodiment of the present disclosure, the integrated fingerprint scanner 102 is situated anywhere on the system 100. In addition, the keyboard 104 is used to enter login credentials of the user. Also, the keyboard 104 is used to onboard details of the new user in the database. The keyboard 104 is situated on left side of the integrated fingerprint scanner 102. The keyboard 104 is easily accessible to the user. In an embodiment of the present disclosure, the keyboard 104 is situated anywhere on the system 100. The login credentials of the user are used to authenticate the user to provide additional security. Furthermore, the plurality of input devices includes the camera 106. The camera 106 captures and stores real-time activities of the user. The real-time activities of the user are stored in form of a plurality of images and live video. In an embodiment of the present disclosure, the camera 106 is used to authenticate the user based on the plurality of images captured and images of the user stored in the database. In an embodiment of the present disclosure, the camera 106 is installed on outer side of the upper compartment 140 of the system 100. In another embodiment of the present disclosure, the camera 106 is hidden inside the upper compartment 140 of the system 100. In an example, the system 100 receives the first set of data in the form of fingerprint of the user. In another example, the system 100 receives the first set of data in the form of login credentials of the user. Further, the system 100 authenticates the user based on the received fingerprint and login credentials of the user.

In an example, let us suppose that the new user wants to create the new account in the system 100. The new user enters any type of unique identification number such as AADHAR number included in AADHAR ID of the user or emirates ID in the system 100 using the keyboard 104. The AADHAR number of the user is verified with a set of data stored on government website containing AADHAR details of all the people in the country. Further, the integrated fingerprint scanner scans fingerprint of the user upon authentication of AADHAR number of the user. The fingerprint of the user is verified with fingerprint details of the user stored on government website containing AADHAR details of all the people in the country. Furthermore, the new account of the new user is created upon authentication of fingerprint details of the user. Also, the new user is provided with customer ID to login into the system 100 with the customer ID from next time and access account of the user.

In another example, the user already has account registered on the system 100. The user enters customer ID of the user provided by the system 100. The system 100 verifies customer ID provided by the user with customer ID stored in the database of the system 100. Further, the integrated fingerprint scanner 102 scans fingerprint of the user upon authentication of customer ID of the user. The fingerprint of the user is verified with fingerprint details of the user stored in the database of the system 100. Furthermore, the user is authenticated to provide the metal asset to the system 100.

Further, the system 100 includes the plurality of inlets. The plurality of inlets is used to accept a plurality of inputs from the user and an operator. The user provides the metal asset through the first inlet 108 from the plurality of inlets (as shown in FIG. 3). In an embodiment of the present disclosure, the first inlet 108 opens up after authentication of the user (as shown in FIG. 3). The first inlet 108 serves as medium to accept the metal asset from the user. Further, the second inlet 110 from the plurality of inlets receives the metal asset from the first inlet 108. In an embodiment of the present disclosure, the second inlet 110 is used to automatically weigh the metal asset. The first inlet 108 is situated on front right corner on top of the upper compartment 140. The first inlet 108 is easily accessible to the user. In an embodiment of the present disclosure, the first inlet 108 is situated anywhere on the system 100. The second inlet 110 is situated below the first inlet 108. In an embodiment of the present disclosure, the second inlet 110 is situated anywhere on the system 100. The first inlet 108 transfers the metal asset from the first inlet 108 to the second inlet 110.

Further, the plurality of inlets 100 includes the third inlet 116a and the fourth inlet 116b on back side of the system 100. In an embodiment of the present disclosure, the third inlet 116a and the fourth inlet 116b are situated anywhere on the system 100. The operator uses the third inlet 116a and the fourth inlet 116b to manually inspect the metal asset. The third inlet 116a and the fourth inlet 116b allow the operator to insert arms inside an inspection region through the third inlet 116a and the fourth inlet 116b (as shown in FIG. 3). The operator is trusted person who has enough wisdom to inspect the metal asset. The operator performs manual inspection in the inspection region to check purity of the metal asset (as shown in FIG. 3). The operator can utilize the electronic purity testing device 148 for testing purity of the precious metals other than gold such as silver, platinum, palladium and other known precious metals. In an embodiment of the present disclosure, the system 100 may accommodate more than one electronic purity testing device 148 for checking purity of each different precious metal separately. In an example, the operator checks whether the metal asset is real or fake. In addition, the operator performs manual inspection in the inspection region to check fineness of the metal asset. In an example, the operator checks whether the metal asset is 18 carat, 22 carat, 24 carat and the like.

Further, the manual inspection in the inspection region is done using a plurality of inspection devices. The plurality of inspection devices include one or more high resolution cameras, the set of tamper proof gloves 112, the touchstone 114, the electronic purity testing device 148 for testing purity of precious metals, one or more lighting devices, the viewfinder 146 and the like. The manual inspection of the metal asset is done using the touchstone 114. In an embodiment of the present disclosure, the set of tamper proof gloves 112 and the touchstone 114 are kept in the upper compartment of the system 100. In another embodiment of the present disclosure, the set of tamper proof gloves 112 and the touchstone 114 are kept anywhere in the system 100. The manual inspection of the metal asset is done using the touchstone 114. The manual inspection of the metal asset is done using the touchstone 114. In an embodiment of the present disclosure, the manual inspection of the metal asset is done using a plurality of acids. In addition, the electronic purity testing device 148 is configured to test purity of precious metals other than gold such as silver. The electronic purity testing device 148 may be any device known in the art for testing purity of precious metals other than gold. However, the methods of the manual inspection of the metal asset are not limited to above mentioned methods. In addition, the operator wears the set of tamper proof gloves 112 during manual inspection of the metal asset. The operator wears a left tamper proof glove in left hand of the operator. The operator wears a right tamper proof glove in right hand of the operator.

The operator utilizes the viewfinder 146 to see real-time view of the metal asset (as shown in FIG. 3). In general, the viewfinder is device on camera showing field of view of the lens. In an example, the viewfinder 146 is used as binoculars by the operator to view inside the inspection region. In an embodiment of the present disclosure, the viewfinder 146 is situated in rear side on top of the upper compartment 140 of the system 100. In another embodiment of the present disclosure, the viewfinder 146 is situated anywhere on the system. The inspection region is referred to region where the operator does manual inspection of purity and fineness of the metal asset in the upper compartment 140 of the system 100. The viewfinder 146 is attached to the one or more high resolution cameras. Accordingly, the video imaging mechanism is configured to feed video inputs of the metal asset to a machine learning system in real time (as shown in FIG. 3). The machine learning system may be located remotely from the system through any communication medium. The machine learning system augments manual purity checking process for the metal asset using the video inputs. In addition, the machine learning system improves precision of purity testing by predicting the purity from analysis of the video inputs feed. The machine learning system implements machine learning algorithms for predicting the purity of the metal asset based on analysis of the video inputs fed by the video imaging mechanism. The one or more high resolution cameras associated with the video imaging mechanism are connected to the machine learning system. In addition, the one or more lighting devices provide better illumination inside the inspection region to assist the operator in manual inspection of the metal asset. In an example, the one or more high resolution cameras capture and send images and video captured of the manual inspection of the metal asset to remote panel of trained gold appraisers. The trained gold appraisers assist the operator in manual inspection of purity of the metal asset. Further, the one or more high resolution cameras help in framing and focusing images and video captured of the manual inspection of the metal asset.

Further, the operator puts the metal asset on the second inlet 110 (as shown in FIG. 3). Furthermore, the operator press accept or reject button based on acceptation or rejection of the metal asset (as shown in FIG. 3). The second inlet 110 transfers the metal asset to a weighing mechanism inside the lower compartment 142 of the system 100 if the metal asset is accepted by the operator (as shown in FIG. 3). The weighing mechanism is used to weigh the metal asset (as shown in FIG. 3). The metal asset is weighed after successful inspection of purity of the metal asset by the operator. The metal asset is provided back to the user through the outlet 144 if the metal asset fails in manual inspection (as shown in FIG. 3). In an embodiment of the present disclosure, the outlet 144 is situated in the upper compartment 140 of the system 100. In another embodiment of the present disclosure, the outlet 144 is situated anywhere in the system 100.

Further, the weighing mechanism includes the lowering device 118. The lowering device 118 is a device that lowers the metal asset from the second inlet 110 to the precision weighing scale 120. In an example, the lowering device 118 lowers the metal asset from the second inlet 110 to the lower compartment 142 of the system 100. In an embodiment of the present disclosure, the lowering device 118 is situated in the lower compartment 142 of the system 100. In another embodiment of the present disclosure, the lowering device 118 is situated anywhere in the system 100. Furthermore, the weighing mechanism includes the basin 122 of the precision weighing scale 120. The basin 122 of the precision weighing scale 120 is used to hold the metal asset during measurement of weight of the metal asset. In an example, the basin 122 of the precision weighing scale 120 acts as support to the metal asset during weighing of the metal asset. In an embodiment of the present disclosure, the basin 122 of the precision weighing scale 120 is situated in the lower compartment 142 of the system 100. In another embodiment of the present disclosure, the basin 122 of the precision weighing scale 120 is situated anywhere in the system 100.

Furthermore, the weighing mechanism includes the precision weighing scale 120. In an embodiment of the present disclosure, the precision weighing scale 120 is situated below the basin 122 of the precision weighing scale 120 in the lower compartment 142 of the system 100. In another embodiment of the present disclosure, the precision weighing scale 120 is situated anywhere in the system 100. The precision weighing scale 120 is used to measure weight of the metal asset (as shown in FIG. 3). The precision weighing scale 120 is electronically connected to the operating system that enables the system 100 to calculate value of the financial asset. The weight of the metal asset is measured to calculate the value of the financial asset to be credited to the user. The metal asset is transferred to the precision weighing scale 120 after manual inspection of the metal asset. In addition, the value of the financial asset to be credited to the user is generated in real-time. The value of the financial asset is generated based on a plurality of factors. In an embodiment of the present disclosure, the system 100 generates one or more loan options that may be credited to the user. In an embodiment of the present disclosure, the plurality of factors include weight of the metal asset, purity of the metal asset, fineness of the metal asset, current exchange rate of the metal asset and the like. However, the plurality of factors is not limited to above mentioned factors.

The system 100 outputs information associated with the current transaction using a plurality of output devices. The plurality of output devices includes a QR code generator, the integrated thermal printer 136, the screen 138, a speaker, a LED light and the like. The plurality of output devices include the screen 138 to display value of the financial asset to be credited to the user (as shown in FIG. 3). In an embodiment of the present disclosure, the screen 138 is used to display any other information to the user. In an embodiment of the present disclosure, the screen 138 is controlled using the keyboard 104. In another embodiment of the present disclosure, the screen 138 is controlled using the touch screen display. The screen 138 displays the value of the financial asset generated by the system 100 to the user (as shown in FIG. 3). Also, the screen 138 displays the one or more loan options generated by the system 100 to the user (as shown in FIG. 3). In an embodiment of the present disclosure, the screen 138 is situated above the keyboard 104 in the upper compartment 140 of the system 100. In another embodiment of the present disclosure, the screen 138 is situated anywhere in the system 100.

Further, the user accepts the value of the financial asset displayed on the screen 138 if the user is satisfied with the value of the financial asset calculated by the system 100 (as shown in FIG. 3). In an embodiment of the present disclosure, the user selects suitable option from the one or more loan options displayed on the screen 138. The system 100 provides the metal asset back to the user if the user rejects the value of the financial asset provided by the system 100 (as shown in FIG. 3). The system 100 provides the metal asset back to the user through the outlet 144 situated in the upper compartment 140 of the system 100. In an embodiment of the present disclosure, the system 100 stores or documents details about each transaction for documentary evidence to reduce risks of fraud by the operator. The transaction refers to provision of the financial asset to the user in exchange of the metal asset. The details include amount of loan provisioned to the user, user account details, timestamp, image of the user, details of the financial institution such as name, branch and the like, details of the metal asset such as weight, purity level and the like.

Further, the system 100 includes a packaging mechanism. The packaging mechanism is used to pack and mark the metal asset with a QR code (as shown in FIG. 3). The metal asset is transferred to the packaging mechanism when the user accepts the value of the financial asset displayed on the screen 138 (as shown in FIG. 3). The metal asset is transferred to the packaging mechanism from the weighing mechanism through the fifth inlet 126 (as shown in FIG. 3). The packaging mechanism includes the packager 128. In an embodiment of the present disclosure, the packager 128 is situated in the lower compartment 142 of the system 100. In another embodiment of the present disclosure, the packager 128 is situated anywhere in the system 100. The metal asset is transferred to the packager 128 through the tilting pivot 124 for the basin 122 of the precision weighing scale 120. The metal asset is transferred to the packager 128 for secure packaging of the metal asset. The packager 128 packs the metal asset. In addition, the packager 128 marks the packed metal asset with the QR code. In general, the QR code consists of black squares arranged in square grid on white background. In addition, the QR code is generally read by an imaging device such as camera and the like. In general, the QR code is processed using Reed-Solomon error correction until image can be appropriately interpreted. Also, the QR code contains details associated with the current transaction of providing the financial asset to the user in exchange of the metal asset as collateral. The QR code enables identification of the metal asset provided by the user. The QR code is utilized for returning the metal asset to the user when the financial asset is repaid by the user.

The system 100 includes a communication circuitry. The communication circuitry is used to transfer the value of the financial asset to financial account associated with the user (as shown in FIG. 3). The financial account information associated with the user is fetched from the user profile stored in the database. Further, the financial asset is transferred to the financial account of the user after successful inspection of the metal asset and acceptance of value of the financial asset by the user. The communication circuitry connects the system 100 with a communication network. The communication network includes but may not be limited to 2G, 3G, 4G, Wi-Fi, Ethernet, GPRS, Edge and the like. The communication circuitry connects the system 100 with a payment gateway using the communication network. The payment gateway securely transfers the value of the financial asset in the financial account of the user stored in the database. In an embodiment of the present disclosure, the user is allowed to select the financial account of the user on the screen 138 while performing the current transaction.

The communication circuitry connects the system 100 with a server through the communication network. In an embodiment of the present disclosure, the server is cloud server. In general, the cloud server possesses and exhibit similar capabilities and functionality to the server but is accessed remotely from a cloud service provider. In an example, the cloud server is similar to a physical server but provides virtual space for handling all the operations. In another embodiment of the present disclosure, the server is at least one of database server, file server, application server and the like. However, the server is not limited to above mentioned servers.

Further, the server includes the database. In an embodiment of the present disclosure, the database is cloud database. However, the database is not limited to cloud database. The database provides storage location for the user profile, the current transaction details and the financial account associated with the user. In an example, the database is stored on the server. The server interacts with the database to retrieve the stored data.

Further, the packed metal asset is transferred to a secure region. The packed metal asset is transferred to the secure region after acceptance of the value of the financial asset by the user. The sixth inlet 134 transfers the packed metal asset from the packaging mechanism to the secure region. The secure region includes the secure vault 130 (as shown in FIG. 3). In an embodiment of the present disclosure, the secure vault 130 is situated in the lower compartment 142 of the system 100. In another embodiment of the present disclosure, the secure vault 130 is situated anywhere in the system 100. The secure vault 130 is used to store the packed metal asset safely and securely. In an embodiment of the present disclosure, the secure vault 130 is protected inside the lower compartment 142 of the system 100. The secure vault 130 is not accessible to the user. The secure vault 130 is opened by the authorized operator (as shown in FIG. 3). Further, the operator places the packed metal asset inside the secure vault 130 (as shown in FIG. 3). In an embodiment of the present disclosure, the secure vault 130 is maintained by any other person belonging to financial institute that owns the system 100. The secure vault 130 is opened through the secure vault outlet 132. In an embodiment of the present disclosure, the secure vault outlet 132 is situated on back side of the secure vault 130. In another embodiment of the present disclosure, the secure vault outlet 132 is situated anywhere on the secure vault 130. In an embodiment of the present disclosure, the secure vault 130 is protected using lock and key setup. In another embodiment of the present disclosure, the secure vault 130 is opened by entering pin code or password through embedded key panel on the secure vault 130. In another embodiment of the present disclosure, the secure vault 130 is opened by using biometric devices. In an example, the secure vault 130 is opened up using fingerprint scanner, voice recognition device, facial recognition, retina scanner and the like.

Furthermore, the plurality of output devices includes the integrated thermal printer 136. The integrated thermal printer 136 is used to print details of the current transaction (as shown in FIG. 3). The integrated thermal printer 136 prints receipt of the current transaction. Further, the user collects receipt from the integrated thermal printer 136. In an embodiment of the present disclosure, the integrated thermal printer 136 is situated on right side of the screen 138 in the upper compartment 140 of the system 100. In another embodiment of the present disclosure, the integrated thermal printer 136 is situated anywhere in the system 100.

In an embodiment of the present disclosure, the system 100 fetches details of the user from one or more web-based platforms associated with the user. The details of the user fetched from the one or more web-based platforms associated with the user are stored in the user profile stored in the database. The details of the user are fetched from the one or more web-based platforms to verify authenticity of the user. In addition, the details of the user fetched from the one or more web-based platforms associated with the user provide financial status of the user. In an example, the one or more web-based platforms include Facebook, Instagram, LinkedIn, Twitter, Gmail, Yahoo, WhatsApp, banking websites and the like. In an embodiment of the present disclosure, the system 100 fetches the financial account associated with the user from the user profile stored in the database. In an example, the financial account associated with the user is fetched from details linked with a country specific authentication means or any type of unique identification number such as AADHAR ID, social security number, emirates ID and the like associated with the user.

In an embodiment of the present disclosure, the system 100 displays rate of interest and time duration of repayment of the financial asset on the screen 138 before authentication of the user. The user is authenticated or creates new account only when the user agrees to the displayed rate of interest and time duration of repayment of the financial asset. In another embodiment of the present disclosure, the user is allowed to choose between one or more options of rate of interest and time duration of repayment of the financial asset on the screen 138.

In an embodiment of the present disclosure, the system 100 transfers the value of the financial asset to digital wallet associated with the user. In an embodiment of the present disclosure, the financial account information associated with the user includes details of digital wallets and digital accounts associated with the user. In an example, the user is allowed to choose to transfer the value of the financial asset in digital wallet, digital account or bank account associated with the user. In an example, the digital wallets include Pay™, Airtel money, Citrus Pay, Oxigen and the like.

In an embodiment of the present disclosure, the camera 106 is used to authenticate the user in the system 100. The plurality of images captured by the camera 106 in real-time are mapped with images stored in the user profile in the database. The quality of the plurality of images captured with the camera 106 in real time is mapped with the quality of images of the user stored in the user profile. The system 100 uses hardware-run machine learning algorithms to map specifications of the plurality of images image captured by the camera 106 in real-time and specifications of images of the user present in the user profile in the database. Further, the system 100 authenticates the user applying for the financial asset. The specifications of the stored images are normalized to a general value to map with specifications of the plurality of images captured with the camera 106 with a little amount of tolerance. In an embodiment of the present disclosure, the system 100 opens up the second inlet 110 after authentication of the user.

In an embodiment of the present disclosure, the system 100 provides authentication of the user by integration of unique identity services. In an example, the unique identity services include country specific identity authentication means or any type of unique identification number such as AADHAR authentication API, emirates ID and the like. In an embodiment of the present disclosure, the system 100 creates the account of the new user by using electronic Know Your Customer (e-KYC) API. However, authentication of the user is not limited to the above mentioned API. However, onboarding of the new user is not limited to the above mentioned API.

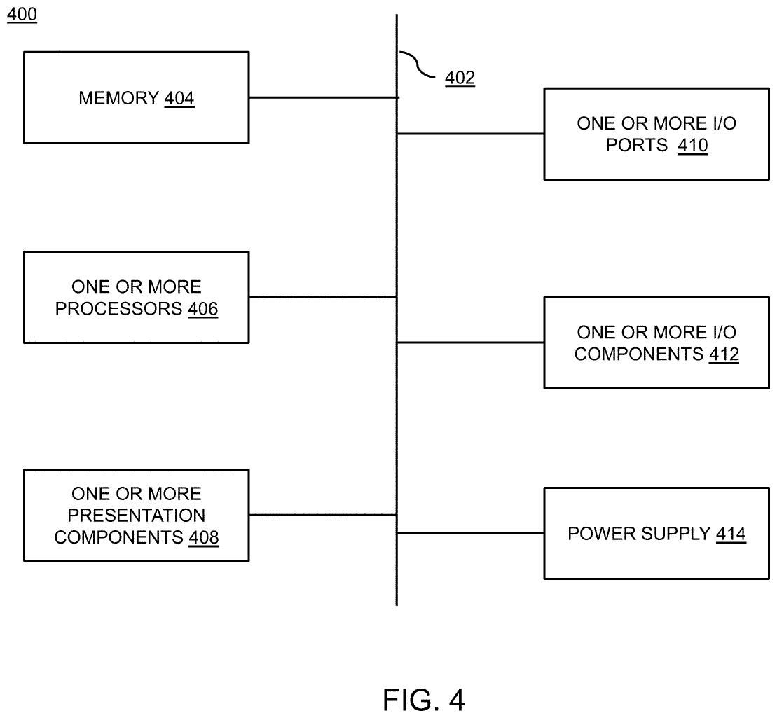

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from various entities such as memory 404 or I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

We claim:

1. A system for providing financial asset to a user in exchange of metal asset, the system comprising:
a plurality of input devices, wherein the plurality of input devices is used to receive a first set of data from the user, wherein the first set of data is used to authenticate the user;
a plurality of inlets, wherein the plurality of inlets is used to accept a plurality of inputs from the user and an operator, wherein the user provides the metal asset through a first inlet of the plurality of inlets, wherein the first inlet opens up after authentication of the user, wherein the operator uses a third inlet of the plurality of inlets and a fourth inlet of the plurality of inlets to manually inspect the metal asset, wherein the operator performs manual inspection in an inspection region to check purity and fineness of the metal asset;
a video imaging mechanism, wherein the video imaging mechanism is configured to feed video inputs to a machine learning system in real time, wherein the machine learning system augments manual purity checking process for the metal asset using the video inputs, wherein the machine learning system predicts purity of the metal asset based on analysis of the video inputs;
a weighing mechanism, wherein the weighing mechanism is used to weigh the metal asset, wherein the metal asset is weighed after successful inspection of purity of the metal asset by the operator;
a packaging mechanism, wherein the packaging mechanism is used to pack and mark the metal asset with a QR code, wherein the QR code enables identification of the metal asset provided by the user, wherein the QR code is utilized for returning the metal asset to the user when the financial asset is repaid by the user, wherein the packed metal asset is transferred to a secure region through a sixth inlet from the plurality of inlets; and
a communication circuitry, wherein the communication circuitry is used to transfer value of the financial asset to financial account associated with the user, wherein the financial account information associated with the user is fetched from a user profile stored in a database, wherein the financial asset is transferred to the financial account of the user after successful inspection of the metal asset and acceptance of value of the financial asset by the user.

2. The system as recited in claim 1, wherein the metal asset comprises one of gold, silver, platinum and valuable metals, wherein the metal asset is exchanged to receive the financial asset.

3. The system as recited in claim 1, wherein the first set of data is received from the plurality of input devices, wherein the first set of data comprises login credentials and one or more proof of identity or any type of unique identification number associated with the user, wherein the plurality of input devices comprise an integrated fingerprint sensor, a keyboard, a camera, a touchscreen display and a plurality of biometric devices.

4. The system as recited in claim 1, wherein the first set of data is used to fetch a second set of data associated with the user, wherein the second set of data comprises demographic information, financial account information, fingerprint details, details stored in one or more proof of identity or associated with any type of unique identification number associated with the user.

5. The system as recited in claim 1, wherein the plurality of inlets comprises:
the first inlet, wherein the first inlet receives the metal asset from the user after authentication of the user;
a second inlet from the plurality of inlets, wherein the second inlet receives the metal asset from the first inlet, wherein the second inlet transfers the metal asset to the weighing mechanism;
the third inlet and the fourth inlet, wherein the third inlet and the fourth inlet allows the operator to manually inspect the metal asset;
a fifth inlet from the plurality of inlets, wherein the fifth inlet transfers the metal asset to the packaging mechanism from the weighing mechanism; and
the sixth inlet, wherein the sixth inlet transfers the packed metal asset from the packaging mechanism to the secure region.

6. The system as recited in claim 1, wherein the manual inspection in the inspection region is done using a plurality of inspection devices, wherein the plurality of inspection devices comprise one or more high resolution cameras, a set of tamper proof gloves, a touchstone, electronic purity testing device for testing purity of precious metals, one or more lighting devices and a viewfinder.

7. The system as recited in claim 1, wherein the weighing mechanism comprises:
a lowering device, wherein the lowering device lowers the metal asset from the second inlet to a precision weighing scale;
a basin of the precision weighing scale, wherein the basin of the precision weighing scale is used to hold the metal asset during measurement of weight of the metal asset; and
the precision weighing scale, wherein the precision weighing scale is used to measure weight of the metal asset, wherein the weight of the metal asset is measured to calculate value of the financial asset to be provided to the user, wherein the metal asset is transferred to the precision weighing scale after manual inspection of the metal asset.

8. The system as recited in claim 1, wherein the system outputs information associated with current transaction using a plurality of output devices, wherein the plurality of output devices comprises a QR code generator, an integrated thermal printer, a screen, a speaker and a LED light.

9. The system as recited in claim 1, wherein the metal asset is provided back to the user through an outlet, wherein the metal asset is provided back to the user when the metal asset is rejected in manual inspection by the operator, and wherein the metal asset is provided back to the user when the user rejects the value of the financial asset provided by the system and wherein the system stores or documents details about each transaction related to provision of the financial asset provided to the user for documentary evidence to reduce risks of fraud by the operator.

10. The system as recited in claim 1, wherein the packed metal asset is transferred to the secure region, wherein the packed metal asset is transferred to the secure region after acceptance of value of the financial asset generated, wherein the value of the financial asset is generated in real-time based on a plurality of factors.

11. A system for providing financial asset to a user in exchange of metal asset, the system comprising:
a plurality of input devices, wherein the plurality of input devices is used to receive a first set of data from the user, wherein the first set of data is used to authenticate the user;
a plurality of inlets, wherein the plurality of inlets is used to accept a plurality of inputs from the user and an operator, wherein the user provides the metal asset through a first inlet of the plurality of inlets, wherein the first inlet opens up after authentication of the user, wherein the operator uses a third inlet of the plurality of inlets and a fourth inlet of the plurality of inlets to manually inspect the metal asset, wherein the operator performs manual inspection in an inspection region to check purity and fineness of the metal asset;
a video imaging mechanism, wherein the video imaging mechanism is configured to feed video inputs to a machine learning system in real time, wherein the machine learning system augments manual purity checking process for the metal asset using the video inputs, wherein the machine learning system predicts purity of the metal asset based on analysis of the video inputs;
a weighing mechanism, wherein the weighing mechanism is used to weigh the metal asset, wherein the metal asset is weighed after successful inspection of purity of the metal asset by the operator;
a packaging mechanism, wherein the packaging mechanism is used to pack and mark the metal asset with a QR code, wherein the QR code enables identification of the metal asset provided by the user, wherein the QR code is utilized for returning the metal asset to the user when the financial asset is repaid by the user, wherein the packed metal asset is transferred to a secure region through a sixth inlet from the plurality of inlets; and
a communication circuitry, wherein the communication circuitry is used to transfer value of the financial asset to financial account associated with the user, wherein the financial account information associated with the user is fetched from a user profile stored in a database, wherein the financial asset is transferred to the financial account of the user after successful inspection of the metal asset and acceptance of value of the financial asset by the user, wherein the system outputs information associated with current transaction using a plurality of output devices, wherein the plurality of output devices comprises a QR code generator, an integrated thermal printer, a screen, a speaker and a LED light.

12. The system as recited in claim 11, wherein the metal asset comprises one of gold, silver, platinum and valuable metals, wherein the metal asset is exchanged to receive the financial asset.

13. The system as recited in claim 11, wherein the first set of data is received from the plurality of input devices, wherein the first set of data comprises login credentials and one or more proof of identity or any type of unique identification number associated with the user, wherein the plurality of input devices comprise an integrated fingerprint sensor, a keyboard, a camera, a touchscreen display and a plurality of biometric devices.

14. The system as recited in claim 11, wherein the first set of data is used to fetch a second set of data associated with the user, wherein the second set of data comprises demographic information, financial account information, fingerprint details, details stored in one or more proof of identity or associated with any type of unique identification number associated with the user.

15. The system as recited in claim 1, wherein the plurality of inlets comprises:
the first inlet, wherein the first inlet receives the metal asset from the user after authentication of the user;
a second inlet from the plurality of inlets, wherein the second inlet receives the metal asset from the first inlet, wherein the second inlet transfers the metal asset to the weighing mechanism;
the third inlet and the fourth inlet, wherein the third inlet and the fourth inlet allows the operator to manually inspect the metal asset;
a fifth inlet from the plurality of inlets, wherein the fifth inlet transfers the metal asset to the packaging mechanism from the weighing mechanism; and
the sixth inlet, wherein the sixth inlet transfers the packed metal asset from the packaging mechanism to the secure region.

16. The system as recited in claim 11, wherein the manual inspection in the inspection region is done using a plurality of inspection devices, wherein the plurality of inspection devices comprise one or more high resolution cameras, a set of tamper proof gloves, a touchstone, electronic purity testing device for testing purity of precious metals, one or more lighting devices and a viewfinder.

17. The system as recited in claim 11, wherein the weighing mechanism comprises:
a lowering device, wherein the lowering device lowers the metal asset from the second inlet to a precision weighing scale;
a basin of the precision weighing scale, wherein the basin of the precision weighing scale is used to hold the metal asset during measurement of weight of the metal asset; and
the precision weighing scale, wherein the precision weighing scale is used to measure weight of the metal asset, wherein the weight of the metal asset is measured to calculate value of the financial asset to be provided to the user, wherein the metal asset is transferred to the precision weighing scale after manual inspection of the metal asset.

18. The system as recited in claim 11, wherein the metal asset is provided back to the user through an outlet, wherein the metal asset is provided back to the user when the metal asset is rejected in manual inspection by the operator, and wherein the metal asset is provided back to the user when the user rejects the value of the financial asset provided by the system and wherein the system stores or documents details about each transaction related to provision of the financial asset provided to the user for documentary evidence to reduce risks of fraud by the operator.

19. The system as recited in claim 11, wherein the packed metal asset is transferred to the secure region, wherein the packed metal asset is transferred to the secure region after acceptance of value of the financial asset generated, wherein the value of the financial asset is generated in real-time based on a plurality of factors.
